(19) United States
(12) Patent Application Publication
(10) Pub. No.: US 2023/0257537 A1
(43) Pub. Date: Aug. 17, 2023

(54) TOPCOAT COMPOSITIONS AND FILMS FOR TOUCHABLE SURFACES

(71) Applicant: EASTMAN CHEMICAL COMPANY, KINGSPORT, TN (US)

(72) Inventors: JOHN EVAN BOISSEAU, KINGSPORT, TN (US); JAMIE SUE DZICZKOWSKI, KINGSPORT, TN (US); IGOR TOKAREV, JOHNSON CITY, TN (US)

(73) Assignee: EASTMAN CHEMICAL COMPANY, KINGSPORT, TN (US)

(21) Appl. No.: 18/162,751

(22) Filed: Feb. 1, 2023

Related U.S. Application Data
(60) Provisional application No. 63/311,062, filed on Feb. 17, 2022.

(51) Int. Cl. C08J 5/18; C08G 18/42; C08G 18/73; C09J 7/38; B32B 7/12; B32B 25/14; B32B 27/40

(52) U.S. Cl. CPC C08J 5/18; C08G 18/4227; C08G 18/73; C09J 7/38; B32B 7/12; B32B 25/14; B32B 27/40; C08J 2375/06; C09J 2400/226; B32B 2307/51; B32B 2255/10; B32B 2255/26

(57) ABSTRACT

Stretchable films are disclosed, that include a coating layer comprising the reaction product of: an oligomeric polyester resin wherein the oligomeric polyester resin has a glass transition temperature (Tg) of −15 to 10° C., a hydroxyl equivalent weight of 350 to 500 mgKOH/g; and an aliphatic isocyanate, isocyanurate, allophanate, or biuret. The coating of these films has a fingerprint removal haze under 2, a percent haze removal over 70 percent, an initial scratch/mar over 40% gloss retention, and a recovered scratch/mar over 85% gloss retention as measured by both % gloss retention after 24 hours and % gloss retention at 60° C., as defined herein.

### FIELD OF THE INVENTION

The present invention is generally directed to a topcoat composition designed to meet the needs of touchable surfaces.

### BACKGROUND OF THE INVENTION

Stretchable films such as paint protection films used to protect automotive panels, coated wood, and the like, are generally comprised of a thermoplastic elastomer with a thermoset coating applied to one major surface, and an adhesive on the opposing major surface. It is desirable for these protective films to be stretchable to enable conforming to three dimensional objects, as well as resistant to environmental factors, and those intended to be touchable should also be resistant to fingerprints and bacterial contamination. Other touchable surfaces would likewise benefit from such improvements.

Today, there has been a steady increase in the use of touchable surfaces. Examples of touchable display systems include cellular phones, tablets, computer screens, and even touch screen appliances. The key properties required of most of these touchable surfaces include resistance to scratching/marring and resistance to fingerprinting.

There are advantages to using a laminate film structure to provide these properties, as opposed to simply a coating, as a laminate film can also protect surfaces from damage due to various types of impact. Laminate protection films, such as paint protection films used to protect automotive panels, coated wood, and the like, are generally comprised of a thermoplastic elastomer with a thermoset coating applied to one major surface, and an adhesive on the opposing major surface. Resistance to environmental factors is generally provided by this thermoset coating. Some of these film products might incorporate surface additives, anti-microbial additives, and even nano-technology additives in attempts to provide specific individual properties to the consumer. However, none of these existing films have optimized the chemical composition of the coating so as to provide an optimal combination of fingerprint resistance and scratching/marring resistance required for touch surfaces even when additives are used. In addition, it is advantageous for these protective films to be stretchable to enable conforming to three dimensional objects, whereby the stretchability and viscoelastic properties of the topcoat portion of the film stack also needs to be optimized simultaneous with scratch/mar and fingerprint resistance.

A continuing need exists to discover a stretchable, multilayer film comprising a protective topcoat and a thermoplastic polyurethane that provides improved scratch/mar and fingerprint resistance.

### SUMMARY OF THE INVENTION

In one aspect, the present invention relates to stretchable films that include a coating layer comprising the reaction product of: an oligomeric polyester resin wherein the oligomeric polyester resin has a glass transition temperature (Tg) of −15 to 10° C., and a hydroxyl equivalent weight of 350 to 500 mg KOH/g; and an aliphatic isocyanate, isocyanurate, allophanate, or biuret, wherein the coating has a fingerprint removal haze under 2, a percent haze removal over 70 percent, an initial scratch/mar over 40% gloss retention, and a recovered scratch/mar over 85% gloss retention as measured by both gloss retention after 24 hours and % gloss retention at 60° C., as defined herein.

Further aspects of the invention are as disclosed and claimed herein.

### BRIEF DESCRIPTION OF THE DRAWING

FIG. 1 is a chart showing the resin Tg and equivalent weight relationship used to identify a group of OH functional polyester resins for a design space.

### DETAILED DESCRIPTION

In one embodiment, the invention relates to stretchable films that include a coating layer comprising the reaction product of: an oligomeric polyester resin wherein the oligomeric polyester resin has a glass transition temperature (Tg) of −15 to 10° C., and a hydroxyl equivalent weight of 350 to 500 mgKOH/g; and an aliphatic isocyanate, isocyanurate, allophanate, or biuret. In this aspect, the coating has a fingerprint removal haze under 2, a percent haze removal over 70 percent, an initial scratch/mar over 40% gloss retention, and a recovered scratch/mar over 85% gloss retention as measured by both % gloss retention after 24 hours and % gloss retention at 60° C., as defined herein.

In a second embodiment, according to the first embodiment, the oligomeric polyester resin may comprise from about 45 to about 65 mole % 1,6-hexanediol, and from about 2 to about 15 mole % of a branched alkyl diol having 4-8 carbon atoms, for example, 2,2-dimethyl-1,3-propanediol, and from about 5 to about 25 mole % of a 2,2,4,4-tetraalkylcyclobutane-1,3-diol, for example 2,2,4,4-tetramethyl-1,3-cyclobutanediol, and from about 15 to about 35 mole % 1,1,1-trimethylolpropane or 1,1,1-trimethylolethane, based on the total moles of hydroxyl components; and from about 30 to about 70 mole % isophthalic acid, and from about 20 to about 50 mole % one or more of hexahydrophthalic anhydride, methyl hexahydrophthalic, or tetrahydrophthalic anhydride, and especially hexahydrophthalic anhydride, and from about 10 to about 30 mole % of one or more cyclic or acyclic aliphatic acids having from 2 to 12 carbons based on the total moles of acid components.

In a third embodiment, according to any of the preceding embodiments, the oligomeric polyester resin may comprise from about 50 to about 60 mole % 1,6-hexanediol, and from about 5 to about 10 mole % 2,2-dimethyl-1,3-propanediol, and from about 10 to about 20 mole % 2,2,4,4-tetramethyl-1,3-cyclobutanediol, and from about 20 to about 30 mole % 1,1,1-trimethylolpropane based on the total moles of hydroxyl components; and from about 40 to about 60 mole % isophthalic acid, and from about 25 to about 40 mole % hexahydrophthalic anhydride, and from about 15 to about 25 mole % adipic acid based on the total moles of acid components.

In a fourth embodiment, according to any of the preceding embodiments, the oligomeric polyester resin comprises from about 40 to about 50 mole % isophthalic acid.

In a fifth embodiment, according to any of the preceding embodiments, the oligomeric polyester resin comprises from about 5 to about 15 mole % terephthalic acid.

In a sixth embodiment, according to any of the preceding embodiments, the branched alkyl diol having 4-8 carbon atoms comprises one or more of 2,2-dimethyl-1,3-propanediol, 2-butyl-, 2-ethyl-1,3-propanediol, or 2-methyl-1,3-propanediol.

In a seventh embodiment, according to any of the preceding embodiments, the 2,2,4,4-tetraalkylcyclobutane-1,3-diol comprises one or more of: 2,2,4,4-tetramethylcyclobutane-1,3-diol (TMCD), 2,2,4,4-tetraethylcyclobutane-1,3-diol, 2,2,4,4-tetra-n-propylcyclobutane-1,3-diol, and 2,2,4,4-tetra-n-butylcyclobutane-1,3-diol.

In an eighth embodiment, according to any of the preceding embodiments, the oligomeric polyester resin has a number average molecular weight of 500 to 10,000 mgKOH/g, and a weight average molecular weight of 1000 to 40,000.

In a ninth embodiment, according to any of the preceding embodiments, the films may further comprise a thermoplastic elastomer substrate, adjacent the coating layer.

In a tenth embodiment, according to any of the preceding embodiments, the films may further comprise a pressure sensitive adhesive layer, on a side of the thermoplastic elastomer substrate opposite the coating layer

In an eleventh embodiment, according to any of the preceding embodiments, the films may further comprise a thermoplastic polyurethane substrate, adjacent the coating layer.

In a twelfth embodiment, according to any of the preceding embodiments, the oligomeric polyester resin may have a glass transition temperature (Tg) of −12 to 8° C., and a hydroxyl equivalent weight of 375 to 475 mgKOH/g.

In a thirteenth embodiment, according to any of the preceding embodiments, the oligomeric polyester resin may have a glass transition temperature (Tg) of −10 to 5° C., and a hydroxyl equivalent weight of 400 to 475 mgKOH/g.

In a fourteenth embodiment, according to any of the preceding embodiments, the oligomeric polyester resin has a glass transition temperature (Tg) of −5 to 0° C., and a hydroxyl equivalent weight of 425 to 465 mgKOH/g.

In a fifteenth embodiment, according to any of the preceding embodiments, the oligomeric polyester resin has a number average molecular weight of 750 to 7,500 mgKOH/g, and a weight average molecular weight of 1500 to 30,000.

In a sixteenth embodiment, according to any of the preceding embodiments, the oligomeric polyester resin has a number average molecular weight of 1000 to 5,000 mgKOH/g, and a weight average molecular weight of 1800 to 25,000.

In a seventeenth embodiment, according to any of the preceding embodiments, the thickness of the coating layer is from 0.1 to 25 microns thick.

In an eighteenth embodiment, according to any of the preceding embodiments, the thickness of the coating layer is from 1 to 15 microns thick.

In a nineteenth embodiment, according to any of the preceding embodiments, the aliphatic diisocyanate is present and is selected from one or more of: methylenebis-4,4′-isocyanatocyclohexane, isophorone diisocyanate, isocyanurates of isophorone diisocyanate, 1,6-hexamethylene diisocyanate, isocyanurates of 1,6-hexamethylene diisocyanate, 1,4-cyclohexane diisocyanate, pentane-1,5-diisocyanate, 1,4-bis(isocyanatomethyl)cyclohexane, or a polyisocyanate.

In a twentieth embodiment, according to any of the preceding embodiments, the aliphatic diisocyanate is present and corresponds to one of the following structures:

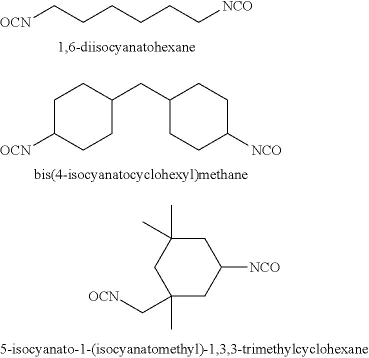

In a twenty-first embodiment, according to any of the preceding embodiments, the mole ratio of oligomeric polyester resin to aliphatic isocyanate or isocyanurate, is from 0.95 to 1.05.

In a twenty-second embodiment, according to any of the preceding embodiments, the stretchable film exhibits an elongation at break of at least 50%.

In a twenty-third embodiment, according to any of the preceding embodiments, the stretchable film exhibits an elongation at break of at least 60%.

In one aspect, then the present invention is directed to stretchable, multilayer films that comprise a thermoplastic elastomeric substrate, for example a thermoplastic polyurethane, coated with a cross-linked, coating layer that possesses an optimal combination of scratch/mar resistance, fingerprint-resistance and stretchability. This coating can optionally contain additives that further enhance its scratch/mar, fingerprint resistance and/or antimicrobial properties. This laminate film can potentially be used on multiple types of touchable surfaces.

The coating layer is the reaction product of an oligomeric polyester resin or blends of oligomeric polyester resins, as diols or polyols, the coating possessing a glass transition temperature (Tg) of −15 to 10° C. and a hydroxyl equivalent weight of 350 to 500 mgKOH/g.

The oligomeric polyester resins of the invention are reacted with an aliphatic isocyanate, isocyanurate, allophanate, or biuret to obtain the thermoset coating. The stretchable, multilayer film may further comprise an adhesive layer, opposite the thermoset coating, for use, for example, as a paint protection film. This adhesive may be a pressure sensitive adhesive. The stretchable multilayer films, including the coating layer, exhibit an elongation to break of greater than 50%, have fingerprint removal haze under 2, a percent haze removal over 70 percent, an initial scratch/mar over 40% gloss retention, and a recovered scratch/mar over 85% gloss retention as measured by both gloss retention after 24 hours and % gloss retention at 60 C, as defined herein.

In one aspect, this invention provides a resin composition for a coating that possesses an optimal combination of scratching/marring and fingerprint-resistant properties. This coating can optionally contain additives that enhance its scratch/mar, fingerprint resistance and/or antimicrobial properties. This coating can potentially be used on multiple types of touchable surfaces. This invention also provides specific test methods that demonstrate the unique ability of this coated film structure to optimize the scratching/marring, and fingerprint properties for the end user.

In one aspect, the present invention is directed to stretchable, multilayer films that comprise a thermoplastic elastomeric substrate, for example a thermoplastic polyurethane, coated with a cross-linked, thermoset coating that possesses an optimal combination of scratch/mar resistance, fingerprint-resistance and stretchability. This coating can optionally contain additives that further enhance its scratch/mar, fingerprint resistance and/or antimicrobial properties. This laminate film can potentially be used on multiple types of touchable surfaces.

Based on the experimental data, compositions with Tg values less than 10° C., or from 10 to −15° C., or from 5 to −15° C., or from 0 to −15° C., or from −5 to −15° C., or from −10 to −15° C., or from 10 to −10° C., or from 5 to −10° C., or from 0 to −10° C., or from −5 to −10° C., or from 10 to −5° C., or from 5 to −5° C., or from 0 to −5° C., or from 10 to 0° C., or from 5 to 0° C., or from 10 to 5° C. and hydroxyl equivalent weight (eqwt OH) values greater than 300, or from 300 to 600, or from 300 to 550, or from 300 to 500, or from 300 to 450, or from 300 to 400, or from 300 to 350, preferably greater than 350, or from 350 to 600, or from 350 to 550, or from 350 to 500, or from 350 to 450, or from 350 to 400, or from 400 to 600, or from 400 to 550, or from 400 to 500, or from 400 to 450, or from 430 to 500, or from 430 to 470, or from 450 to 600, or from 450 to 550, or from 450 to 500, or from 500 to 600, or from 500 to 550, or from 550 to 600, would be the optimum design space for said invention.

These coatings or coated laminate films would provide a fingerprint removal haze under 2, a percent haze removal over 70 percent, an initial scratch/mar over 40% gloss retention, and a recovered scratch/mar over 85% gloss retention as measured by both % gloss retention after 24 hours and % gloss retention at 60° C., as defined herein. According to the invention, the stretchable, multilayer films exhibit improved balance of fingerprint resistance and scratch/mar resistance. In various embodiments, the stretchable, multilayer films of the invention have fingerprint removal haze under 2, a percent haze removal over 70 percent, an initial scratch/mar over 40% gloss retention and a recovered scratch/mar over 85% gloss retention as measured by both % gloss retention after 24 hours and % gloss retention at 60° C., as defined herein. In one aspect, the present invention is directed to stretchable, multilayer films that comprise a thermoplastic elastomeric substrate, for example a thermoplastic polyurethane, coated with a cross-linked, thermoset coating that possesses an optimal combination of scratch/mar resistance, fingerprint-resistance and stretchability. This coating can optionally contain additives that further enhance its scratch/mar, fingerprint resistance and/or antimicrobial properties. It is possible that additives could allow the use of resins outside the space, but those formulas may require a higher level of additives and may compromise other areas of the coating performance for touchable surfaces, such as anti-microbial performance. This laminate film can potentially be used on multiple types of touchable surfaces.

A specific resin Tg range and hydroxyl equivalent weight range is important for thermoset coating systems to optimize both the scratch/mar resistance as well as fingerprint resistance for the formula used in this invention. Also, lower molecular weight resins would typically be used in this type of film coating application. This formula is part of a film layer composition that could be used on optical surfaces such as vehicle navigation screens. Films for these screens not only require scratch/mar and fingerprint resistance, but also optical clarity as well as anti-microbial performance. Inferred are also the ability to properly handle and install the film plus inherent impact protection from the total composition of the film layer.

In this embodiment, the resin technologies of choice are hydroxyl functional polyester resins. The crosslinking groups of choice in this invention are poly-isocyanate groups, but other crosslinking technologies such as melamine resins, benzoguanamine resins, acidic resins, silane resins, and other types that can crosslink with functional groups to form a thermoset coating. This invention uses a tin catalyst and an inhibitor to properly control the crosslinking between the hydroxyl and the isocyanate reactions of said coating formulas. Many different types of catalysts could be used including zinc salts and bismuth salts in addition to any chemistry that could speed the natural rate of the NCO—OH crosslinking reaction. Any combination of solvents can be used to control the application properties of the liquid coating including viscosity, % solids and the conductivity/resistivity of the composition to properly transfer the coating formula to the intended substrate.

The coating formulas in this invention are applied to a thermoplastic polyurethane substrate (TPU) although many other types of thermoplastic as well as glass and metal substrates could be used. The opposite side of the TPU typically contains a pressure sensitive adhesive (PSA), which could be coated and constructed of multiple chemistries. The PSA used in this invention may be acrylic based chemistry that self-crosslinks to provide the necessary properties for the final film application to the final surface for product use.

We have discovered, according to the invention, that a stretchable, multilayer film may be formed of a thermoplastic elastomeric substrate provided with a thermoset coating that maintains the integrity of the coating layer when stretched. The thermoplastic, elastomeric substrate, typically a thermoplastic polyurethane, is suitable for use on touchable display systems including cellular phones, tablets, computer screens, and even touch screen appliances, and is thus stretchable in an amount, for example, of up to 50% elongation. While thermoplastic polyurethanes are known to be elastomeric in structure, we have surprisingly developed a stretchable multilayer film having a thermoset coating that allows the entire multilayer film to stretch up to 50% elongation to break, a fingerprint removal haze under 2, a percent haze removal over 70 percent, an initial scratch/mar over 40% gloss retention and a recovered scratch/mar over 85% gloss retention, as measured by the methods defined herein. While thermoset coatings similar to those described herein are known to be useful as metal coatings, for example for use on automobiles or as can coatings, they typically do not stretch to any appreciable extent.

For the purposes of this invention, a “stretchable multilayer film” is one that can be reversibly elongated to a strain of at least 50% without cracking. A further aspect of a “stretchable film” is that the force required to reversibly elongate the film is low, as this makes it easier for an installer to conform the film to an automotive surface.

Unless otherwise indicated, all numbers expressing quantities of ingredients, properties such as molecular weight, reaction conditions, and so forth used in the specification and claims are to be understood as being modified in all instances by the term “about.” Unless indicated to the contrary, the numerical parameters set forth in the following specification and attached claims are approximations that may vary depending upon the desired properties sought to be obtained by the present invention. At the very least, each numerical parameter should be construed in light of the number of reported significant digits and by applying ordinary rounding techniques. Further, the ranges stated in this disclosure and the claims are intended to include the entire range specifically and not just the endpoint(s). For example, a range stated to be 0 to 10 is intended to disclose all whole numbers between 0 and 10 such as, for example 1, 2, 3, 4, etc., all fractional numbers between 0 and 10, for example 1.5, 2.3, 4.57, 6.1113, etc., and the endpoints 0 and 10. Also, a range associated with chemical substituent groups such as, for example, “C1 to C5 diols”, is intended to specifically include and disclose C1, C2, C3, C4 and C5 diols.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in its respective testing measurements.

As used in the specification and the appended claims, the singular forms “a,” “an” and “the” include their plural referents unless the context clearly dictates otherwise. For example, a reference to a “polyester,” a “dicarboxylic acid”, a “residue” is synonymous with “at least one” or “one or more” polyesters, dicarboxylic acids, or residues and is thus intended to refer to both a single or plurality of polyesters, dicarboxylic acids, or residues. In addition, references to a composition “comprising”, “containing”, “having” or “including” “an” ingredient or “a” polyester is intended to include other ingredients or other polyesters, respectively, in addition to the specifically identified ingredient or residue. Accordingly, the terms “containing”, “having” or “including” are intended to be synonymous and may be used interchangeably with the term “comprising”, meaning that at least the named compound, element, particle, or method step, etc., is present in the composition or article or method, but does not exclude the presence of other compounds, catalysts, materials, particles, method steps, etc., even if the other such compounds, material, particles, method steps, etc., have the same function as what is named, unless expressly excluded in the claims.

Also, it is to be understood that the mention of one or more process steps does not preclude the presence of additional process steps before or after the combined recited steps or intervening process steps between those steps expressly identified. Moreover, the lettering of process steps or ingredients is a convenient means for identifying discrete activities or ingredients and the recited lettering can be arranged in any sequence, unless otherwise indicated.

The stretchable, multilayer films of the invention may thus comprise a thermoset coating, and a thermoplastic elastomeric substrate on which the thermoset coating is applied. The thermoset coating is made from an oligomeric polyester resin having substantial aliphatic content, for example comprising residues of trimethylolpropane, neopentyl glycol, and an aliphatic diacid such as adipic acid. The oligomeric polyester resins useful according to the invention may comprise further amounts of diol or polyols, as well as further amounts of dicarboxylic acids or polycarboxylic acids.

The oligomeric polyester resins of the invention are prepared by the polycondensation of one or more acid components and one or more hydroxyl components. These acid components are understood to have at least two carboxylic acid units, and thus are either dicarboxylic acids or polycarboxylic acids, as the case may be. Similarly, these hydroxyl components are understood to have at least two hydroxyl units, and thus are either diols or polyols, as the case may be. As used herein, the word “polyol” describes monomeric units used to construct oligomeric polyester resins and will include monomeric units having two or more hydroxyl groups. Similarly, the word “polycarboxylic acid” as used herein describes monomeric units used to construct oligomeric polyester resins and will include monomeric units having two or more carboxylic acid groups. We will often refer, for convenience, to the terms “diols or polyols” and “dicarboxylic acids or polycarboxylic acids” as the two types of reactants used to form the oligomeric polyester resins of the invention. As used throughout, the molar percentage of each of the diols or polyols is based on the total moles of diols or polyols present. Similarly, the molar percentage of each of the dicarboxylic acids or polycarboxylic acids is based on the total moles of dicarboxylic acids or polycarboxylic acids present.

As used herein, the oligomeric polyester resins of the invention are distinguished from the thermoset coatings that have been reacted with an aliphatic isocyanate, isocyanurate, allophanate, or biuret. The oligomeric polyester resins of the invention are relatively low molecular weight, aliphatic, thermoplastic polyesters that serve as polyol reactants to form the thermoset coatings of the invention when reacted with an aliphatic isocyanate or isocyanurate. Depending on context, the term isocyanate may include isocyanurates, allophanates, or biurets.

The thermoset coatings of the present invention are thus thermoset polymers and are adapted for coating a thermoplastic elastomeric substrate. That is, the oligomeric polyester resins are formulated with aliphatic isocyanates or isocyanurates, optionally with minor amounts of aromatic isocyanates, so that the thermoset coating is suitable for use to protect the thermoplastic elastomeric substrate, while maintaining the desirable stretchability, and improved balance of scratch resistance and fingerprint resistance. These oligomeric polyester resins thus would not be suitable as stand-alone polymers for fabrication of films, sheets, and other shaped objects by extrusion, casting, blow molding, and other thermoforming processes commonly used for high molecular weight thermoplastic polymers. The oligomeric polyester resins have reactive functional groups, that is hydroxyl groups and/or carboxyl groups, which later react with the aliphatic isocyanate in a coating formulation. The functional groups of the oligomeric polyester resins are controlled by having either excess polyol or polycarboxylic acid in the oligomeric polyester resin composition. The desired crosslinking pathway will determine whether the polyester resin will be hydroxyl-terminated or carboxylic acid-terminated. This concept is known to those skilled in the art and described, for example, in Organic Coatings Science and Technology, 2nd ed., p. 246-257, by Z. Wicks, F. Jones, and S. Pappas, Wiley, New York, 1999, the entire disclosure of which is incorporated herein by reference.

The acid components in the oligomeric polyester resin are prepared from dicarboxylic acids and polycarboxylic acids having from 1 to 12 carbon atoms. Typically, the acid components, described herein generically as the polycarboxylic acids, comprise at least one dicarboxylic acid and may, optionally, include polycarboxylic acids. The acid components may comprise aliphatic polycarboxylic acids, although they may also comprise aromatic polycarboxylic acids such as isophthalic acid, terephthalic acid, phthalic acid, or residues derived from phthalic anhydride.

These aliphatic polycarboxylic acids can be further separated into acyclic and cyclic variants. The acyclic aliphatic dicarboxylic acids comprise from 1 to 60 mole %, 1 to 50 mole %, 1 to 40 mole %, 1 to 30 mole %, 1 to 20 mole %, 1 to 10 mole %, 10 to 60 mole %, 10 to 50 mole %, 10 to 40 mole %, 10 to 30 mole %, 10 to 20 mole %, 20 to 60 mole %, 20 to 50 mole %, 20 to 40 mole %, 20 to 30 mole %, 30 to 60 mole %, 30 to 50 mole %, 30 to 40 mole %, 40 to 60 mole %, 40 to 50 mole %, or 50 to 60 mole % based on the total moles of the acyclic aliphatic and cyclic aliphatic diacids.

Acyclic aliphatic acids useful according to the invention thus include oxalic acid, malonic acid, succinic acid, glutaric acid, adipic acid, pimelic acid, suberic acid, undecanedioic acid, maleic acid, fumaric acid, itaconic acid, citraconic acid, dodecanedioic acid, sebacic acid, azelaic acid, acetylene dicarboxylic acid, glutaconic acid, traumatic acid, dimer acid, hydrogenated dimer acid, and the like, or their residues. Adipic acid is a desired acyclic aliphatic acid.

Cyclic aliphatic acids useful according to the invention include 1,4 cyclohexanedicarboxylic acid, 1,3 cyclohexanedicarboxylic acid, hexahydrophthalic anhydride (HHPA), methyl hexahydrophthalic anhydride, tetrahydrophthalic anhydride, tetrachlorophthalic anhydride, 5-norbornene-2,3-dicarboxylic anhydride, 5-norbornene-2,3-dicarboxylic acid, 2,3-norbornanedicarboxylic acid, 2,3-norbornanedicarboxylic acid anhydride, and mixtures thereof, or their residues. HHPA (hexahydrophthalic anhydride), methyl hexahydrophthalic, and tetrahydrophthalic anhydride, and especially HHPA, are desired cyclic aliphatic diacids.

The hydroxyl components in the oligomeric polyester resin are prepared from diols and polyols typically having from 2 to 20 carbon atoms. As noted, the term polyols includes diols, depending on context.

The diols useful according to the invention comprise those having 2 hydroxyl groups that are branched or linear, saturated or unsaturated, aliphatic or cycloaliphatic C2-C20 compounds, the hydroxyl groups being primary, secondary, and/or tertiary, desirably primary. The diols and polyols useful according to the invention thus include 2,2-dimethyl-1,3-propanediol (neopentyl glycol), 1,2-cyclohexanedimethanol, 1,3-cyclohexanedimethanol, 1,4-cyclohexanedimethanol, 2,2,4-trimethyl-1,3-pentanediol, hydroxypivalyl hydroxypivalate, 2-methyl-1,3-propanediol, 2-butyl-2-ethyl-1,3-propanediol, 2-ethyl-2-isobutyl-1,3-propanediol, 1,3-butanediol, 1,4-butanediol, 1,5-pentanediol, 1,6-hexanediol, 2,2,4,4-tetramethyl-1,6-hexanediol, 1,10-decanediol, 1,4-benzenedimethanol, ethylene glycol, propylene glycol, diethylene glycol, dipropylene glycol, triethylene glycol, tetraethylene glycol, and polyethylene glycol, and mixtures thereof, or their residues. Thus, branched alkyl diols having 4 to 8 carbon atoms, for example, 2,2-dimethyl-1,3-propanediol, 2-butyl-, 2-ethyl-1,3-propanediol, or 2-methyl-1,3-propanediol, are especially useful according to the invention.

The polyols useful according to the invention may comprise those having 3 or more hydroxyl groups, saturated or unsaturated, aliphatic or cycloaliphatic C2 to C20 compounds, the hydroxyl groups being primary, secondary, and/or tertiary, and desirably at least two of the hydroxyl groups are primary. Desirably, the polyols are hydrocarbons and do not contain atoms other than hydrogen, carbon and oxygen. Examples of these polyols include 1,1,1-trimethylolpropane (TMP), 1,1,1-trimethylolethane, glycerin, pentaerythritol, erythritol, threitol, di-pentaerythritol, sorbitol, and mixtures thereof, or their residues.

In other aspects, the oligomeric polyester resins of the invention may further comprise one or more cycloaliphatic diols, such as, for example, a 2,2,4,4-tetraalkylcyclobutane-1,3-diol, for example 2,2,4,4-tetramethyl-1,3-cyclobutanediol. Other suitable 2,2,4,4-tetraalkylcyclobutane-1,3-diols include 2,2,4,4-tetraethylcyclobutane-1,3-diol, 2,2,4,4-tetra-n-propylcyclobutane-1,3-diol, and 2,2,4,4-tetra-n-butylcyclobutane-1,3-diol.

In one aspect, the oligomeric polyester resins of the invention may comprise from about 50 to about 60 mole % 1,6-hexanediol, and from about 5 to about 10 mole % 2,2-dimethyl-1,3-propanediol, and from about 10 to about 20 mole % 2,2,4,4-tetramethyl-1,3-cyclobutanediol, and from about 20 to about 30 mole % 1,1,1-trimethylolpropane based on the total moles of hydroxyl components; and from about 40 to about 60 mole % isophthalic acid, and from about 25 to about 40 mole % hexahydrophthalic anhydride, and from about 15 to about 25 mole % adipic acid based on the total moles of acid components.

Catalysts may be used to accelerate the rate of the polycondensation reaction to form the in the oligomeric polyester resin.

Additional examples of acid components and hydroxyl components, include those known in the art including, but not limited to, those discussed below, and in various documents known in the art such as, for example, in Resins for Surface Coatings, Vol. III, p. 63-167, ed. by P. K. T. Oldring and G. Hayward, SITA Technology, London, U K, 1987, the disclosure of which is incorporated herein by reference.

The term “residue”, as used herein in reference to the oligomeric polyester resins of the invention, means any organic structure incorporated into a polymer through a polycondensation or ring opening reaction involving the corresponding monomer. It will also be understood by persons having ordinary skill in the art, that the residues associated within the various curable polyesters of the invention can be derived from the parent monomer compound itself or any derivative of the parent compound. For example, the dicarboxylic acid residues referred to in the polymers of the invention may be derived from a dicarboxylic acid or its associated acid halides, esters, salts, anhydrides, or mixtures thereof. Thus, as used herein, the term “polycarboxylic acid” in its broadest sense is intended to include polycarboxylic acids and any derivative of a polycarboxylic acid, including its associated acid halides, esters, half-esters, salts, half-salts, anhydrides, and mixtures thereof, useful in a polycondensation process with a diol to make a curable, aliphatic polyester.

When we say that a residue is present, we thus mean that it is present as the reaction product of the monomer(s) used. We assume that the amount reacted is the amount present in the reacted material.

The term “aliphatic,” is intended to have its common meaning as would be understood by persons having ordinary skill in the art, that is, acyclic or cyclic, saturated or unsaturated carbon compounds, excluding benzenoid or other aromatic systems. The term “cycloaliphatic”, or “cyclic aliphatic,” as used herein, is intended to mean a cyclic, aliphatic compound. The term “aliphatic polyester”, as used herein, is understood to mean a polyester that contains, for example, 90 mole percent or greater aliphatic diacid or diol residues, based on the total moles of diacid or diol residues. Small amounts, such as less than 10 mole %, or less than 9 mole %, or less than 8 mole %, or less than 5 mole %, or less than 3 mole %, or less than 2 mole %, or less than 1 mole % of aromatic dicarboxylic acids residues or aromatic diol residues also may be present in the curable, aliphatic polyester. Desirably, the curable, aliphatic oligomeric polyester resin, is essentially free, i.e., having less than 1 mole %, of aromatic diacid and/or aromatic diol residues.

In another aspect, the stretchable, multilayer films of the invention exhibit an elongation to break of greater than 50%, or greater than 60%, or greater than 65%, as determined by the method described herein.

The hydroxyl equivalent weight of the oligomeric polyester resins of the present invention is greater than 300, or from 300 to 600, or from 300 to 550, or from 300 to 500, or from 300 to 450, or from 300 to 400, or from 300 to 350, or greater than 350, or from 350 to 600, or from 350 to 550, or from 350 to 500, or from 350 to 450, or from 350 to 400, or from 400 to 600, or from 400 to 550, or from 400 to 500, or from 400 to 450, or from 430 to 500, or from 430 to 470, or from 450 to 600, or from 450 to 550, or from 450 to 500, or from 500 to 600, or from 500 to 550, or from 550 to 600.

Fingerprint resistance is a desirable feature of films used to cover touchable surfaces. If a fingerprint smudge is not easily removed, it becomes difficult to see through the film. In addition, the presence of fingerprint smudges is aesthetically displeasing. We have found that the fingerprint resistance properties in the coatings of this invention are optimized by lowering OH equivalent weight and increasing the glass transition temperature. Thus, the various embodiments of this invention provide a thermoset coating, made from oligomeric polyester resins, that is applied to a thermoplastic elastomeric substrate to obtain a stretchable, multilayer film.

Likewise, films used to cover touchable surfaces also need to be resistant to initial scratches, while still being able to heal most light scratches in a very short time frame. We have found that improved overall scratch/mar performance may be achieved by using resins that are low in Tg and high in eqwt OH. While both initial scratch resistance and fingerprint resistance is enhanced with a higher eqwt OH, self-healing scratch resistance requires a relatively low Tg which is contrary to what is required to generate good fingerprint resistance. Thus, creating a coating for a film with both good fingerprint resistance and good scratch resistance requires an optimal range of Tg and eqwt OH.

In one aspect, the films of the invention exhibit a fingerprint resistance less than 2, a percent haze removal over 70 percent, an initial scratch/mar over 40% gloss retention and a recovered scratch/mar over 85% gloss retention, as measured by the methods defined herein.

In another aspect, the stretchable, multilayer films of the invention exhibit an elongation to break of greater than 50%, or greater than 60%, or greater than 65%, as determined by the method described herein. Both fingerprint resistance and scratch resistance have been found to adversely affect stretchability, which of course is a highly desirable feature of the protective films of the invention. It is thus highly desirable for the laminate film to achieve good fingerprint resistance and scratch/mar resistance while maintaining required stretchability.

The number average molecular weight (Mn) of the oligomeric polyester resins of the present invention may be from about 500 to about 10,000, or from 800 to 6,000, or from 1,000 to 4,000 g/mole. The weight average molecular weight (Mw) of the curable oligomeric polyester resins of the present invention may be from about 1,000 to about 40,000, from 1,000 to 25,000, or from 2,000 to 20,000 g/mole. Molecular weights are measured by gel permeation chromatography (GPC) using polystyrene equivalent molecular weight and tetrahydrofuran (THF) as solvent In other aspects, the Mw molecular weight may be at least about 1,000, or at least 1,500, or at least 2,000, up to about 20,000, or up to about 21,000, or up to 22,000, or up to about 24,000, or up to about 25,000, or up to about 40,000.

The isocyanate crosslinker of the thermoset coating is desirably an aliphatic isocyanate or aliphatic polymeric isocyanate type. Suitable isocyanates include, but are not limited to, methylenebis-4,4′-isocyanatocyclohexane, isophorone diisocyanate, isophorone diisocyanate, 1,6-hexamethylene diisocyanate, 1,4-cyclohexane diisocyanate, pentane-1,5-diisocyanate, 1,4-bis(isocyanatomethyl)cyclohexane. The isocyanate crosslinker of the thermoset coating also includes polymeric isocyanates of the monomeric isocyanates listed above, This includes, but is not limited to isocyanurates, allophanates, and biurets. There can also be employed isocyanate terminated adducts of diols and polyols, such as ethylene glycol, 1,4-butylene glycol, trimethylol propane, etc. These are formed by reacting more than one mole of a diisocyanate, such as those mentioned, with one mole of a diol or polyol to form a higher molecular weight isocyanate prepolymer with a functionality of 2 to 3. Examples include those isocyanate crosslinkers under the Desmodur and Mondur trade names from Covestro LLC. Where isocyanates are used as crosslinkers, it is preferred to use aliphatic isocyanates, since they provide better outdoor durability and color stability in the cured coating. Examples include 1,6-hexamethylene diisocyanate, 1,4-butylene diisocyanate, methylene bis (4-cyclohexyl isocyanate) and isophorone diisocyanate. Mixtures of isocyanate crosslinkers can also be employed. The desirable isocyanate crosslinkers also include modified isocyanates, for example, carbodiimide modified isocyanates, silane modified isocyanates, and blocked isocyanates.

Generic structures of the building blocks for the desirable isocyanate are shown below.

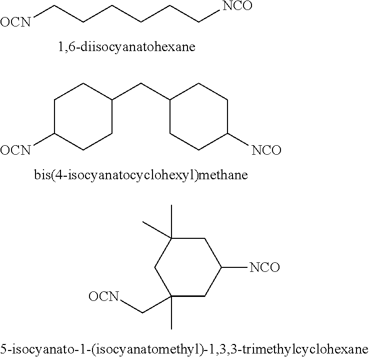

As used herein, an allophanate is the reaction product of an isocyanate disclosed herein and a urethane. Biuret is a reaction product of two or more isocyanates as disclosed herein.

The minor amounts of aromatic isocyanate may include toluene diisocyanate, methylene diphenyl isocyanate as well as polymeric allophanates, isocyanurates, and biurets of these materials.

The thermoset coating compositions of the invention may further contain one or more other crosslinkers known in the art that could react with hydroxyl groups or residual acid groups of the inventive polyesters. One example is melamine or “amino” type crosslinkers that can react with hydroxyl groups. Another example is epoxides that could react with residual acid groups.

Stoichiometric calculations for the polyester resin and isocyanate reaction are known to those skilled in the art and are described in The Chemistry of Polyurethane Coatings, Technical Publication p. 20, by Bayer Material Science, 2005, incorporated herein by reference. Theoretically, crosslinking between the polyester resin and isocyanate reaches maximum molecular weight and optimal properties associated with molecular weight when one equivalent of isocyanate (NCO) reacts with one equivalent of hydroxyl (OH), which is when the NCO to OH ratio is 1.0/1.0. It is common practice to use a small excess of isocyanate, about 5 to 10%, to allow for the likely consumption of isocyanate by moisture from the atmosphere, solvents and pigments. It is sometimes desirable to vary the NCO to OH ratio less than 1.0/1.0 to improve flexibility or greater than 1.0/1.0 for harder, more chemical resistant and more weather resistant coatings.

In a preferred embodiment, NCO to OH ratio may be from 0.5 to 1.5, or from 0.75 to 1.25, or from 0.8 to 1.2, or from 0.85 to 1.15, or from 0.9 to 1.1, or from 0.95 to 1.05.

In another aspect, this invention further provides a thermoset coating composition that may further comprise one or more cross-linking catalysts. Useful catalysts may include tertiary amines, such as triethylene diamine, N-methyl morpholine, N-ethyl morpholine, diethyl ethanolamine, 1-methyl-4-dimethylamino ethyl piperazine, 3-methoxy-N-dimethyl propyl amine, N-dimethyl-N′-methyl isopropyl propylene diamine, N,N-diethyl-3-diethyl amino propylamine, N,N-dimethyl benzyl amine, dicyclohexylmethylamine, 2,4,6-tris dimethylaminomethylphenol, N,N-dimethyl cyclohexylamine, triethylamine, tri-n-butylamine, 1,8-diaza-bichloro[5,40]-undecene-7 N-methyl diethanolamine, N,N-dimethyl ethanolamine, N,N-diethyl cyclohexylamine, N,N,N′N′-tetramethyl-ethylene diamine, 1,4-diaza-bicyclo-[2,2,2]-octane N-methyl-N-dimethylaminoethyl-piperazine, bis-(N,N-diethylaminoethyl)-adipate, N,N-diethylbenzylamine, pentamethyldiethylene triamine, N,N,N′,N′-tetramethyl-1,3-butanediamine, 1,2-dimethylimidazole, 2-methylimidazole; tin compounds, such as stannous chloride, dibutyl tin di-2-ethyl hexoate, stannous octoate, dibutyl tin dilaurate, trimethyl tin hydroxide, dimethyl tin dichloride, dibutyl tin diacetate, dibutyl tin oxide, tributyl tin acetate, tetramethyl tin, dimethyl dioctyl tin, tin ethyl hexoate, tin laurate, dibutyl tin maleate, dioctyl tin diacetate; other metal organics, such as zinc octoate, phenyl mercuric propionate, lead octoate, lead naphthenate, and copper naphthenate. Particularly useful, for the present invention, is dibutyl tin dilaurate (DBTDL). Useful amounts of catalyst will be about 0.01 to 5%, based on the total weight of the resin solids.

The thermoset coating composition may also contain one or more leveling, rheology, and flow control agents such as silicones, fluorocarbons or cellulosics; wetting agents; flatting agents; pigment wetting and dispersing agents; surfactants; ultraviolet (UV) absorbers; UV light stabilizers; tinting pigments; defoaming and antifoaming agents; anti-settling, anti-sag and bodying agents; anti-skinning agents; anti-flooding and anti-floating agents; fungicides and mildewicides; corrosion inhibitors; thickening agents; flow agents; rheology control agents; slip agents; oleophobic agents; superhydrophobic agents; or coalescing agents. Specific examples of such additives can be found in Raw Materials Index, published by the National Paint & Coatings Association, 1500 Rhode Island Avenue, N.W., Washington, D.C. 20005.

In some useful embodiments, the thermoset coating compositions described herein may include a flattening agent. Flattening agents are generally small solid particles of material that are insoluble in water and are effective to reduce gloss. Preferably, the flattening agent particles have a size of from about 0.05 to about 10 microns but may be present in clumps or agglomerates of up to about 50 microns. The flattening agent particles may be inorganic or organic. Examples of suitable inorganic flattening agents include silicates, such as talc, and various forms of silica, such as amorphous, aerogel, diatomaceous, hydrogel and fumed silicas. Examples of suitable organic flattening agents include insoluble urea-formaldehyde resins, polyethylene, polypropylene, cellulosic fibers and polyurethane/polyurea copolymers.

If desired, the thermoset coating compositions can comprise other functional materials such as dye colorants, pigments, abrasion resistant particles (like NANOBYK™ additives from BYK Chemie), anti-oxidants, thixotropic agents, and fillers. Examples of pigments include those generally recognized by persons of ordinary skill in the art of surface coatings. For example, the pigment may be a typical organic or inorganic pigment, especially those set forth in the Colour Index, 3rd ed., 2nd Rev., 1982, published by the Society of Dyers and Colourists in association with the American Association of Textile Chemists and Colorists. Other examples of suitable pigments include titanium dioxide, barytes, clay, calcium carbonate, CI Pigment White 6 (titanium dioxide), CI Pigment Black 7, CI Pigment Black 11, CI Pigment Black 22, CI Pigment Black 27, CI Pigment Black 28, CI Pigment Red 101 (red iron oxide), CI Pigment Yellow 42, CI Pigment Blue 15,15:1,15:2,15:3,15:4 (copper phthalocyanines); CI Pigment Red 49:1 and CI Pigment Red 57:1. Colorants such as, for example, phthalocyanine blue, molybdate orange, or carbon black also may be added to the thermoset coating composition.

The thermoset coating compositions of the invention may further comprise a hydrophobicity-enhancing additive, for example a monofunctional silicone component provided with a hydroxyl, amino, or epoxy functionality. If a monofunctional material is used, it may serve as a chain-terminating agent during polymerization, or cross-linking.

The additive may thus be one or more of monoglycidyl ether terminated poly(dimethylsiloxane), diglycidyl ether terminated poly(dimethylsiloxane), bis(3-aminopropyl) terminated poly(dimethylsiloxane) (DMS-A11 available from Gelest), (aminopropylmethylsiloxane)-dimethylsiloxane copolymer (e.g. AMS-132, AMS-152, AMS-162, AMS-163, AMS-191, or AMS-1203 available from Gelest), (aminoethylaminopropylmethylsioxane)-dimethylsiloxane copolymer (e.g. AMS-2202, AMS-233, or AMS-242 available from Gelest), monohydroxyl terminated polydimethylsiloxane (e.g. MCS-C11, MCR-C12, MCR-C18, MCR-C22, or MCS-C13 available from Gelest), hydroxyl terminated polydimethylsiloxane (e.g. DMS-C15 or DMS-C16 available from Gelest), and silanol terminated polydimethylsiloxane (e.g. DMS-S12 available from Gelest).

Any solvent that will enable the formulation to be coated on a substrate may be used, and these will be well known to the person skilled in the art. Suitable organic solvents include glycols, glycol ether alcohols, alcohols, ketones, and aromatics, such as xylene and toluene, acetates, mineral spirits, naphthas and/or mixtures thereof. “Acetates” include the glycol ether acetates. The amount of organic solvent can be up to 60 wt. % based on the total weight of the thermoset coating composition.

Examples of dispersing agents include, but are not limited to, sodium bis(tridecyl) sulfosuccinate, di(2-ethyl hexyl) sodium sulfosuccinate, sodium dihexylsulfosuccinate, sodium dicyclohexyl sulfosuccinate, diamyl sodium sulfosuccinate, sodium diisobutyl sulfosuccinate, disodium isodecyl sulfosuccinate, disodium ethoxylated alcohol half ester of sulfosuccinic acid, disodium alkyl amido polyethoxy sulfosuccinate, tetra-sodium N-(1,2-dicarboxyethyl)-N-octadecyl sulfosuccinamate, disodium N-octasulfosuccinamate, sulfated ethoxylated nonylphenol, 2-amino-2-methyl-1-propanol, and the like.

Examples of viscosity, suspension, and flow control agents include polyaminoamide phosphate, high molecular weight carboxylic acid salts of polyamine amides, and alkylene amine salts of an unsaturated fatty acid, all available from BYK Chemie USA as ANTI TERRA™. Further examples include, but are not limited to, polysiloxane copolymers, polyacrylate solution, cellulose esters, hydroxyethyl cellulose, hydroxypropyl cellulose, polyamide wax, polyolefin wax, hydroxypropyl methyl cellulose, polyethylene oxide, and the like.

Several proprietary antifoaming agents are commercially available and include, but are not limited to, BUBREAK™, available from Buckman Laboratories Inc., BYK™, available from BYK Chemie, U.S.A., FOAMASTER™ and NOPCO™, available from Henkel Corporation Coating Chemicals, DREWPLUS™, available from the Drew Industrial Division of Ashland Chemical Company, TROYSOL™ and TROYKYD™, available from Troy Chemical Corporation, and SAG™, available from Union Carbide Corporation.

Some examples of UV absorbers and UV light stabilizers are substituted benzophenone, substituted benzotriazoles, hindered amines, and hindered benzoates, available from Cytec Specialty Chemicals as CYASORB® UV, and available from Ciba Specialty Chemicals as TINUVIN®; diethyl-3acetyl-4-hydroxy-benzyl-phosphonate, 4-dodecyloxy-2-hydroxy benzophenone, and resorcinol monobenzoate.

As used herein, the thermoplastic elastomeric substrate may comprise a number of thermoplastic elastomers, such as polyurethanes, styrenic block copolymers, polyacrylates, polyolefins, vinyl chloride polymers, polyether-esters, polyamides, ionomers, silicones, and fluoropolymers. The thermoplastic elastomeric substrates of the invention are characterized in part by their elasticity.

In one aspect, the thermoplastic elastomeric substrates comprise thermoplastic polyurethanes, or TPUs. TPUs can be divided into three chemical classes: polyester-based, polyether-based, and polycaprolactone-based. Polyester TPUs are generally compatible with PVC and other polar plastics and provide excellent abrasion resistance, offer a good balance of physical properties and are useful in polymer blends. Polyether-based TPUs offer lower temperature flexibility and good abrasion and tear resistance. They also have good hydrolytic stability. Polycaprolactone-based TPUs have the inherent toughness and resistance of polyester-based TPUs and good low temperature performance and hydrolytic stability.

TPUs can also be subdivided into aromatic and aliphatic TPUs, in this case referring to the diisocyanates used. Aromatic TPUs based on isocyanates like toluene diisocyanate (TDI) and methylene diphenyl diisocyanate (MDI) are the majority of TPUs and are used when strength, flexibility, and toughness are required. However, they typically do not weather well. Aliphatic TPUs based on isocyanates like 4,4′-Methylene dicyclohexyl diisocyanate (H12 MDI), hexamethylene diisocyanate (HDI) and isophorone diisocyanate (IPDI) are light stable and offer excellent clarity. They are commonly used in automotive interior and exterior applications and may be used to bond safety glass together. We have found that aliphatic polycaprolactone-based TPUs offer a good balance of weatherability, low temperature flexibility, and impact resistance needed for many automotive exterior applications, and are especially useful according to the invention.

In a specific aspect, the thermoplastic polyurethanes useful according to the invention as thermoplastic elastomeric substrate may be aliphatic polycaprolactone-based thermoplastic polyurethanes, comprised of a polycaprolactone-based polymeric diol reacted with an aliphatic diisocyanate. In this aspect, the aliphatic diisocyanate may be selected from, for example, 4,4′-Methylene dicyclohexyl diisocyanate (H12 MDI or HMDI), hexamethylene diisocyanate (HDI), and isophorone diisocyanate (IPDI). In this aspect, the polycaprolactone-based polymeric diol is comprised of caprolactone units, a glycol such as ethylene glycol, propylene glycol, neopentyl glycol, or butanediol, and may be initiated by a glycol such as ethylene glycol, diethylene glycol, hexanediol, neopentyl glycol or butane diol. In a preferred aspect, the thermoplastic polyurethane comprises residues of HMDI, 1,4-butanediol, and caprolactone. The polycaprolactone-based polymeric diol used to form the thermoplastic polyurethanes of the invention may have a molecular weight, for example, from about 500 to about 5000, or from about 800 to about 4000, or from 900 to about 3000, or from about 1000 to about 2500.

Other properties of the aliphatic polycaprolactone-based thermoplastic polyurethanes include the inherent toughness and resistance of polyester-based TPUs and good low temperature performance, good weatherability and light fastness and hydrolytic stability.

TPUs useful according to the invention as thermoplastic elastomeric substrates include those disclosed and claimed in U.S. Pat. No. 10,265,932, the disclosure of which is incorporated herein by reference. They are polymers containing urethane (also known as carbamate) linkages, urea linkages, or combinations thereof (i.e., in the case of poly(urethane-urea)s). Thus, polyurethanes useful according to the invention contain at least urethane linkages and, optionally, urea linkages. In one aspect, polyurethane-based layers of the invention are based on polyurethanes where the backbone has at least about 80% urethane and/or urea repeat linkages formed during their polymerization.

TPUs useful according to the invention as thermoplastic elastomeric substrates can include polyurethane polymers of the same or different chemistries, that is, polymer blends. Polyurethanes generally comprise the reaction product of at least one isocyanate-reactive component, at least one isocyanate-functional component, and one or more optional components such as emulsifiers and chain extending agents.

Isocyanate-reactive components useful according to the invention in the TPUs include at least one active hydrogen, such as amines, thiols, and polymeric diols, and especially hydroxyl-functional materials such as polymeric diols that provide urethane linkages when reacted with the isocyanate-functional component. Specific polymeric diols of interest include polyester polymeric diols (e.g., lactone polymeric diols) and alkylene oxide adducts thereof (e.g., ethylene oxide; 1,2-epoxypropane; 1,2-epoxybutane; 2,3-epoxybutane; isobutylene oxide; and epichlorohydrin), polyether polymeric diols (e.g., polyoxyalkylene polymeric diols, such as polypropylene oxide polymeric diols, polyethylene oxide polymeric diols, polypropylene oxide polyethylene oxide copolymer polymeric diols, and polyoxytetramethylene polymeric diols; polyoxycycloalkylene polymeric diols; polythioethers; and alkylene oxide adducts thereof), polyalkylene polymeric diols, polycarbonate polymeric diols, mixtures thereof, and copolymers thereof. Further polymeric diols of interest are those derived from caprolactone, referred to herein as polycaprolactone-based polymeric diols.

The isocyanate-reactive component of the thermoplastic elastomeric substrates of the invention is thus reacted with an isocyanate-functional component to form the TPU. The isocyanate-functional component may contain one isocyanate-functional material or mixtures thereof. Polyisocyanates, including derivatives thereof (e.g., ureas, biurets, allophanates, dimers and trimers of polyisocyanates, and mixtures thereof), (hereinafter collectively referred to as “polyisocyanates”) are preferred isocyanate-functional materials for the isocyanate-functional component. Polyisocyanates have at least two isocyanate-functional groups and provide urethane linkages when reacted with the hydroxy-functional isocyanate-reactive components. In one embodiment, polyisocyanates useful for preparing polyurethanes are one or a combination of any of the aliphatic or optionally aromatic polyisocyanates used to prepare polyurethanes.

The isocyanates of the TPUs are typically diisocyanates, and include aromatic diisocyanates, aromatic-aliphatic diisocyanates, aliphatic diisocyanates, cycloaliphatic diisocyanates, and other compounds terminated by two isocyanate-functional groups (e.g., the diurethane of toluene-2,4-diisocyanate-terminated polypropylene oxide polymeric diol). Diisocyanates useful according to the invention thus include: 2,6-toluene diisocyanate; 2,5-toluene diisocyanate; 2,4-toluene diisocyanate; phenylene diisocyanate; 5-chloro-2,4-toluene diisocyanate; 1-chloromethyl-2,4-diisocyanato benzene; xylylene diisocyanate; tetramethyl-xylylene diisocyanate; 1,4-diisocyanatobutane; 1,6-diisocyanatohexane; 1,12-diisocyanatododecane; 2-methyl-1,5-diisocyanatopentane; methylenedicyclohexylene-4,4′-diisocyanate; 3-isocyanatomethyl-3,5,5′-trimethylcyclohexyl isocyanate (isophorone diisocyanate); 2,2,4-trimethylhexyl diisocyanate; cyclohexylene-1,4-diisocyanate; hexamethylene-1,6-diisocyanate; tetramethylene-1,4-diisocyanate; cyclohexane-1,4-diisocyanate; naphthalene-1,5-diisocyanate; diphenylmethane-4,4′-diisocyanate; hexahydro xylylene diisocyanate; 1,4-benzene diisocyanate; 3,3′-dimethoxy-4,4′-diphenyl diisocyanate; phenylene diisocyanate; isophorone diisocyanate; polymethylene polyphenyl isocyanate; 4,4′-biphenylene diisocyanate; 4-isocyanatocyclohexyl-4′-isocyanatophenyl methane; and p-isocyanatomethyl phenyl isocyanate.

The components of these polyurethanes are further described below with reference to specific hydrocarbon groups, and to polymeric versions thereof. The prefix “poly” is thus added to the corresponding hydrocarbon group. The hydrocarbon groups may include one or more heteroatoms in addition to carbon, and may also contain functional groups such as oximes, esters, carbonates, amides, imides, ethers, urethanes, ureas, carbonyls, or mixtures thereof.

In one aspect, the TPUs useful according to the invention as thermoplastic elastomeric substrates include those made from aliphatic isocyanates and oligomeric polyester resins. The term “aliphatic” means a saturated or unsaturated, linear, branched, or cyclic hydrocarbon group. This term includes alkylene (e.g., oxyalkylene), aralkylene, and cyclo alkylene groups. The term “alkylene group” means a saturated, linear or branched, divalent hydrocarbon group. Preferred alkylene groups include oxyalkylene groups, which are saturated, linear or branched, divalent hydrocarbon groups with a terminal oxygen atom. “Aralkylene groups” are saturated, linear or branched, divalent hydrocarbon groups having at least one aromatic group. The term “cycloalkylene group” means a saturated, linear or branched, divalent hydrocarbon group with at least one cyclic group. The term “oxycycloalkylene group” means a saturated, linear or branched, divalent hydrocarbon group having at least one cyclic group and a terminal oxygen atom. The term “aromatic group” means a mononuclear aromatic hydrocarbon group or polynuclear aromatic hydrocarbon group. This term includes arylene groups. The term “arylene group” means a divalent aromatic group.

Aliphatic isocyanates useful in the thermoplastic elastomeric substrates according to the invention thus include aliphatic groups that may be alkyl groups, alkenyl groups, alkynyl groups, and the like, and may be branched or linear, with linear being advantageous. The aliphatic group may comprise from 2-30 carbon atoms, or from 3-12 carbon atoms, or from 4-10 carbon atoms. Examples include 1,12-diisocyanatododecane; 2-methyl-1,5-diiso-cyanatopentane; methylenedicyclohexylene-4,4′-diisocyanate; 3-isocyanatomethyl-3,5,5′-trimethylcyclohexyl isocyanate (isophorone diisocyanate); 2,2,4-trimethylhexyl diisocyanate; cyclohexylene-1,4-diisocyanate; hexamethylene-1,6-diisocyanate; tetramethylene-1,4-diisocyanate; cyclohexane-1,4-diisocyanate; and isophorone diisocyanate.

One or more chain extenders can also be used in preparing the thermoplastic elastomeric substrates of the invention. For example, such chain extenders can be any or a combination of the aliphatic polymeric diols, aliphatic polyamines, or aromatic polyamines used to prepare polyurethanes. Chain extenders useful according to the invention thus include the following: 1,4-butanediol; propylene glycol; ethylene glycol; 1,6-hexanediol; glycerin; trimethylolpropane; pentaerythritol; 1,4-cyclohexane dimethanol; and phenyl diethanolamine. Also note that diols such as hydroquinone bis(β-hydroxyethyl)ether; tetrachlorohydroquinone-1,4-bis(β-hydroxyethyl)ether; and tetrachlorohydroquinone-1,4-bis(β-hydroxyethyl)sulfide, even though they contain aromatic rings, are considered to be aliphatic polymeric diols for purposes of the invention. Aliphatic diols of 2-10 carbon atoms are preferred. Especially preferred is 1,4-butanediol.

The stretchable, multilayer films of the invention may further comprise a pressure sensitive adhesive (PSA), provided to assist in mounting the films to the surface to which they are to be adhered. These pressure sensitive adhesives may be applied, for example, by means of a release liner, or may be coated onto the thermoplastic elastomeric substrates. Pressure sensitive adhesives useful according to the invention include those disclosed in U.S. Pat. No. 5,883,149, the disclosure of which is incorporated herein by reference in its entirety.

The PSAs useful according to the invention include acrylate pressure sensitive adhesives that include acrylic polymers that may be characterized by their glass transition temperature (Tg). The Tg of the polymer may be from about −55° C. to about 15° C., or from −30° C. to 5° C., or from −25° C. to 0° C. The adhesives according to the invention may comprise from about 25 to about 98 parts, or from 60 to 95 parts, of an acrylic acid ester whose homopolymer has a Tg less than 0° C., or especially less than −20° C.; from about 2 to about 75 parts, or from 5 to 45 parts of an ethylenically unsaturated monomer whose homopolymer has a Tg greater than 0° C., or greater than 10° C.; from 0 to about 15 parts, or from 0 to 10 parts, of an acid- or hydroxyl-bearing polar ethylenically unsaturated monomer. Optionally the adhesive polymer may be blended with a tackifier from 0 to about 50 parts, or from 10 to 30 parts.

The acrylic acid esters that are useful according to the invention are monofunctional acrylic esters of monohydric alcohols having from about 4 to about 18 carbon atoms in the alcohol moiety, whose homopolymer has a Tg less than 0° C. Included in this class of acrylic acid esters are isooctyl acrylate, 2-ethylhexyl acrylate, isononyl acrylate, isodecyl acrylate, decyl acrylate, lauryl acrylate, hexyl acrylate, butyl acrylate, and octadecyl acrylate, or combinations thereof. In the case of octadecyl acrylate, the amount is chosen such that side chain crystallization does not occur at room temperature.

Examples of ethylenically unsaturated monomers whose homopolymer has a Tg greater than 0° C., or greater than 10° C., include, but are not limited to, 3,3,5 trimethylcyclohexyl acrylate, cyclohexyl acrylate, isobornyl acrylate, N-octyl acrylamide, t-butyl acrylate, methyl methacrylate, ethyl methacrylate, propyl methacrylate, N,N dimethylacrylamide, N-vinyl-2-pyrrolidone, N-vinyl caprolactam, acrylonitrile, tetrahydrofurfuryl acrylate, glycidyl acrylate, 2-phenoxyethylacrylate, and benzylacrylate or combinations thereof.

Acid or hydroxyl bearing monomers useful according to the invention include, but are not limited to, acrylic acid, methacrylic acid, methyl acrylate, betacarboxyethyl acrylate, hydroxyethyl acrylate, hydroxyethyl methacrylate, hydroxypropyl acrylate, hydroxypropyl methacrylate, hydroxybutyl acrylate, and hydroxybutyl methacrylate.

These adhesive polymers will optionally include a cross-linker including, but not limited, to metal chelates like aluminum acetylacetonate, and various titanates. Other crosslinkers include, but are not limited to, multifunctional epoxies, silanes, aziridines, isocyanates and/or (meth)acrylates. Optionally the PSA could also include other additives such as tackifiers, plasticizers, UV absorbers/stabilizers, and antioxidants.

While the films of the present invention has been described above in detail with respect to certain exemplary embodiments and end-use utilities, it will be understood by the person of ordinary skill that the films of the present invention may be utilized in a wide variety of end-use applications and with other components as previously described.

The following examples set forth suitable and/or preferred methods and results in accordance with the invention. It is to be understood, however, that these examples are provided by way of illustration and nothing therein should be taken as a limitation upon the overall scope of the invention. All percentages are by weight unless otherwise specified.

### Examples

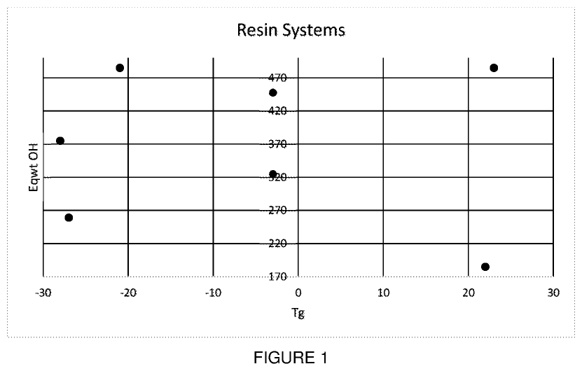

To optimize the resin Tg and equivalent weight relationship, a group of OH functional polyester resins were identified that could outline a design space as shown in FIG. 1 (Resin Design Space). The numbered samples represent the various formulas that were created to test the region within the design space. All of the resins were formulated identically at 1.05:1 NCO:OH, identical catalyst levels and formulated to the sample % non-volatiles for consistent coating application properties. The weights of each of the components required to obtain 50 g formulas for each composition are in Table 1.

TABLE 1
Coating Formula compositions for experimental design space

| | Example | | | | | | |
|---|---|---|---|---|---|---|---|
| Resin | 1 | 2 | 3 | 4 | 5 | 6 | 7 |
| Resin A | 14.5 | | 4.5 | | | 9 | |
| Resin B | | 20.2 | | 13.5 | 4.9 | 8.4 | 6.4 |
| Resin C | | | 9.3 | | | | |
| Resin D | | | | 5.7 | 17 | | |
| Resin E | | | 4.1 | | | | 7.5 |
| Catalyst | 0.1 | 0.1 | 0.1 | 0.1 | 0.1 | 0.1 | 0.1 |
| Inhibitor | 0.4 | 0.4 | 0.4 | 0.4 | 0.4 | 0.4 | 0.4 |
| Solvents | 23 | 22.6 | 21.8 | 23.5 | 19 | 21.9 | 27.1 |
| Crosslinker | 12 | 6.7 | 9.8 | 6.8 | 8.6 | 10.2 | 8.5 |

The components in Table 1 are as follows:

### Catalyst: Dibutyl Tin Dilaurate

### Inhibitor: Acetyl Acetone

### Solvents: MEK, Toluene, and N-Butyl Acetate

Crosslinker: Desmodur N-3300 available from Covestro AG

The properties and compositions of the various resin formulations are shown in Table 2 below and the monomeric compositions of the resin formulations in the examples are shown in Table 3, calculated from Tables 1 and 2.

TABLE 2
Compositions of the polyester resins

| | | | Hydroxyl Components | | | | Acid Components | | |
|---|---|---|---|---|---|---|---|---|---|
| | Eqwt | | HDO | NPG | TMCD | TMP | PIA | HHPA | AD |
| Resin ID | OH | Tg | mole % | mole % | mole % | mole % | mole % | mole % | mole % |
| Resin B | 485 | −21 | 80 | — | — | 20 | 73 | — | 27 |
| Resin C | 400 | 6 | — | 48 | 26 | 26 | — | 65 | 35 |
| Resin E | 325 | −30 | — | 31 | 31 | 38 | — | — | 100 |
| Resin A | 175 | 15 | — | 22 | 10 | 68 | — | 100 | — |
| Resin D | 340 | 37 | — | 21 | 43 | 36 | — | 100 | — |

TABLE 3
Compositions and properties of the polyester resins and blends in the examples

| | | | Hydroxyl Components | | | | Acid Components | | |
|---|---|---|---|---|---|---|---|---|---|
| | | Eqwt | HDO | NPG | TMCD | TMP | PIA | HHPA | AD |
| Example | Tg | OH | mole % | mole % | mole % | mole % | mole % | mole % | mole % |
| 1 | 22 | 185 | — | 22 | 10 | 68 | — | 100 | — |
| 2 | −21 | 485 | 80 | | — | 20 | 73 | — | 27 |
| 3 | −27 | 259 | — | 38 | 23 | 39 | — | 59 | 41 |
| 4 | −3 | 448 | 53 | 7 | 14 | 26 | 49 | 33 | 18 |
| 5 | 23 | 485 | 16 | 17 | 34 | 33 | 15 | 80 | 5 |
| 6 | −3 | 325 | 40 | 11 | 5 | 44 | 37 | 50 | 13 |
| 7 | −28 | 375 | 40 | 15.5 | 15.5 | 29 | 37 | — | 63 |

The components listed in Tables 2 and 3 are as follows:

HDO=1,6-hexanediol

NPG=2,2-dimethyl-1,3-propanediol (neopentyl glycol)

TMCD=2,2,4,4-tetramethyl-1,3-cyclobutanediol

TMP=1,1,1-trimethylolpropane

PIA=isophthalic acid

HHPA=hexahydrophthalic anhydride

AD=adipic acid

Polyesters suitable for use according to the invention may be obtained commercially and blended to obtain the desired monomer content, if desired, or may be prepared according to the following synthetic processes. Those skilled in the art of polyester preparation will be aware of alternative processes that may also be used.

A two-liter reaction kettle may be used, equipped with a heating mantle, mechanical stirrer, thermocouple, nitrogen blanket, oil-heated partial condenser, condensate trap, and water-cooled total condenser. Acid numbers may be determined, if desired, using ASTM method D 1639.

In a first example, in a first stage, when HHPA and TMCD are desired monomers, HHPA, TMCD, triphenylphosphite and xylene may be charged to the reaction kettle, and additional xylene used to fill the condensate trap. The temperature is increased from room temperature to 140° C. over approximately fifty minutes. Agitation will be started when the melt reaches 100° C., and the temperature held at 140° C. until a desired acid number is achieved.

In a second stage, when NPG, TMP, and AD are desired, the NPG, half of the total TMP, AD, and Fascat 4100 catalyst are then added to the reactor and heated to about 230° C. over six hours.

In a third stage, the remaining TMP may be added and the reaction held at 230° C. until a desired final acid number is achieved. The resin may then be cooled to 190° C. and poured through a medium mesh paint filter into a metal paint can.

In another example, a first stage is used in which HHPA, NPG, and triphenylphosphite may be charged to the reaction kettle, with additional xylene used to fill the condensate trap. The temperature may then be increased from room temperature to 140° C. over fifty minutes. Agitation may be started when the melt reaches 75° C., and the temperature held at 190° C. until a desired acid number is achieved. The temperature may then be cooled to 165° C.

In a second stage half of the total TMP, AD, and catalyst may be added to the reactor and then heated to 140° C. and held overnight, if needed and the reaction is then heated to 230° C. over six hours.

In a third stage, the remaining TMP may be added to the reactor and the reaction held at 230° C. until a desired final acid number is achieved. The resin may then be cooled to 190° C. and poured through a medium mesh paint filter into a metal paint can.

In a third example, a two-stage process may be used. In the first stage, HHPA, NPG and triphenylphosphite may be charged to the reaction kettle, with additional xylene used to fill the condensate trap. The temperature may then be increased from room temperature to 100° C. over one hour, with agitation started when the melt reaches 100° C. The temperature may then be held at 130° C. until a desired acid number is achieved.

In the second stage, TMP and Fascat 4100 catalyst may be added to the reactor and heated to 230° C. over four hours. The reaction may then be held at 230° C. until a final desired acid number is achieved. The resin may then be cooled to 190° C. and poured through a medium mesh paint filter into a metal paint can.

In yet another two-stage example, in a first stage, HHPA, TMCD, TMP, adipic acid, triphenylphosphite and xylene may be charged to the reaction kettle, with additional xylene used to fill the condensate trap. The temperature is then increased from room temperature to 100° C. over one hour, with agitation started when the melt reaches 100° C. The temperature may then be held at 195° C. until a desired acid number is achieved.

In a second stage, NPG, TMP, and Fascat 4100 catalyst are added and the reaction heated to 150° C. Temperature is increased to 230° C. over four hours and held at that temperature until a desired final acid number is achieved. The resin is then cooled to 190° C. and poured through a medium mesh paint filter into a metal paint can.

Other known processes for making polyesters may likewise be used and are intended to fall within the scope of the present invention.

As shown in Table 1, none of the formulas use any additional flow or enhancement additives that would affect the recovered scratch/mar or fingerprint properties. The crosslinker levels vary depending on the hydroxyl content of the various resins, and the solvent levels are balanced depending on the % non-volatiles in the resin components.

These formulas were coated with a #14 drawdown bar onto a 6 mil thick film of Argotech 29320 TPU substrate from SWM with a pressure sensitive adhesive (PSA) pre-applied on the opposite side. After coating, the films were initially dried for 2 minutes at 120° C. then placed in a ventilated hood to complete the NCO:OH reaction for 1 week. FTIR analysis is used to validate the completeness of reactions of the samples.

### Oligomeric Polyester Resin Properties

Hydroxyl equivalent weight was determined by esterifying the resin by reaction with excess acetic anhydride in pyridine and then decomposing the unreacted anhydride with water. The resulting acetic acid was then titrated with a standard solution of KOH. The number of milligrams of KOH, which are equivalent to one gram of resin sample, is reported as the hydroxyl number.

Molecular weight was determined by gel permeation chromatography using a refractive index detector with polystyrene standards.

Glass Transition Temperature (Tg) was measured on a differential scanning calorimeter (TA Instruments DSC Q2000 V24.9 Build 121). Residual solvent remaining in the resin from solvent processing could artificially lower the Tg measurement. To obtain a more accurate Tg, the resin sample was first subjected to preconditioning in an oven. About 0.3 g of the resin was placed into a small aluminum weighing pan and heated for one hour at 110° C. A sample was then transferred to the differential scanning calorimeter. On the first heating cycle, the sample was heated under nitrogen atmosphere from −50° C. to 140° C. at a rate of 20° C./min. The sample was then quench cooled to −50° C. For the second heating cycle, the sample was heated under the same conditions as those used in the first heating cycle. The midpoint of the second heating cycle is reported as the Tg of the sample.

### Experimental Methods

Recovered Scratch/Mar Test

For testing of scratch/mar resistance, or recovered scratch/mar, 2″×6″ films were cut and laminated onto black automotive OEM test panels that were also 2″×6″ in size. All the test panels were cut from the same larger (18″×24″) panel to insure consistency in the test results. After lamination of the films to the panels, they were stored overnight to allow full activation of the PSA to the automotive paint surface.

To perform the testing, a Crockmeter, abrasive paper, gloss meter, hot plate and temperature strips were used. The specific equipment used in this testing is as follows:

Atlas M238DD electric Crockmeter;

3M polishing paper part #337303 9 micron/1200 grit texture;

BYK glossmeter capable of measuring 20-degree gloss per ASTM D523-14;

standard hot plate capable of reaching 60° C.;

thermolabel test temperature strips for 130° F. (54.4° C.).

To start the testing, the glossmeter was used to measure a 20-degree gloss value on the panels prior to putting them on the Crockmeter for performing the recovered scratch/mar portion of the test. The panel flat was laid on the Crockmeter stage using the frame to hold the panel in place. A 1.5″×1.5″ piece of the polishing paper was cut and the supplied clamp used to install it over the plastic peg, dark side of the paper facing the test surface. It was insured that the paper was totally flat with no wrinkles on the bottom and that both of the supplied weights were installed on top of the plastic peg. This represents 9N of force during the measurement. The counter on the Crockmeter was set to 10 cycles, then the peg/polishing paper was lowered onto the test surface. The instrument was started, insuring the panel did not slip during the measurements and that good contact was made. After the 10 cycles, the panel was removed and immediately a 20 degree gloss value of the marred surface was measured. Multiple gloss measurements were taken across the marred surface until a consistent minimum gloss value was achieved. The test panel was left to recover for 24 hours then the gloss testing repeated on the marred portion to determine the % gloss retention after 24 hours.

### Percent Gloss Retention at 60° C.

The last step was to measure self-healing at an elevated temperature. It has been determined using temperature measurements inside vehicles, that the temperature of automotive interior surfaces can easily reach 60° C. on a typical summer day. Given this consideration, the percent gloss retention at 60° C. method was carried out as follows:

A hot plate was preheated to 60° C. and a 130° F. (54.4° C.) test strip installed on a non-marred portion of the test panel. The panel was placed on the hot plate until the temperature strip indicated the panel temperature had reached 130° F. (54.4° C.). Once the indicator strip had darkened to show the desired temperature, a timer was started for 10 minutes to allow for the healing process. After 10 minutes, the sample was removed from the hot plate, allowing 5 minutes for the sample to cool to room temperature, when the 20 degree gloss was re-measured over the marred area of the test panel.

Visual observation was used in addition to the glossmeter to help assess poor and good performance in the overall scratch/mar and self-healing testing.

In each case the % gloss retention was calculated by dividing the minimum gloss at each step by the original gloss and multiplying by 100 to get a percentage. This process was repeated for all of the test panels in the design. The data is shown below in Table 4.

TABLE 4
Crockmeter scratch/mar/self healing data

| | | | | % gloss | % gloss |
|---|---|---|---|---|---|
| | | | Initial Scratch | retention | retention |
| Example | Tg | eqwt OH | % retention | after 24 hr | at 60° C. |
| 1 | 22 | 185 | 22.9 | 27.0 | 32.9 |
| 2 | −21 | 485 | 90.8 | 94.0 | 93.1 |
| 3 | −27 | 259 | 34.1 | 36.6 | 75.6 |
| 4 | −3 | 448 | 44.2 | 93.0 | 89.5 |
| 5 | 23 | 485 | 24.7 | 22.2 | 70.4 |
| 6 | −3 | 325 | 17.6 | 25.9 | 68.2 |
| 7 | −28 | 375 | 91.8 | 85.3 | 92.9 |

The objective was to maximize the % gloss retention across the entire scope of testing, i.e., less damage occurred during the original scratch by the Crockmeter, and the recovery was excellent at both room and elevated temperatures. In looking at the data above, example 2 yields the best overall scratch/mar performance followed by examples 7 and 4.

### Fingerprint Removal Haze and Percent Haze Removal Tests

To evaluate the fingerprinting resistance, a method was developed as follows: The instruments are the Byk Haze-Gard plus, the Atlas Crockmeter, small pieces of microfiber cloth, and 2″×6″ pieces of Gorilla® Glass.

To begin the procedure, again films were cut to 2″×6″ and laminated to pieces of Gorilla® Glass that were the same size (2″×6″). Gorilla® Glass was chosen as it is a popular display material for items such as cell phones, tablets, and vehicle navigation screens.

Using a black fine tip marker, 5 uniformly spaced 1″ diameter circles were drawn on the back side of the glass. A US 25 cent piece (quarter) is perfect for doing this. Using the haze gard, an initial haze value was recorded inside one of the circles putting the film side of the glass up to the haze port on the instrument. The Gorilla® Glass was removed from the instrument and placed onto a flat surface. Using a thumb, a couple of swipes onto the forehead were performed to collect a skin oil sample for use. (Note—it is important to use real skin oils, as they contain skin cells within them that affect the resulting measurements and also to perform testing a number of hours after personal hygiene to insure the ability to collect sufficient quantities of skin oils.) The thumb was pressed onto the area of the measured circle with moderate force for approximately 2 seconds to deposit the fingerprint. Again, using the haze-gard, the haze of the fingerprint area was measured, again positioning the fingerprint against the haze port of the instrument. After measurement of the fingerprint haze, the glass panel was taken to the Atlas Crockmeter where the panel was placed on the stage of the instrument, using the frame to keep it in position. Using no weight on top of the instrument, the microfiber cloth was attached to the plastic peg on the instrument, insuring again that the cloth was applied completely flat without any wrinkles. The instrument was set to 1 pass, the instrument was started to complete one pass across the fingerprint area with the microfiber cloth. The panel as returned to the BYK Haze-gard instrument, and a haze value recorded specifically in the area where the cloth moved across the fingerprint. If necessary, a small template of black paper with a hole the size of a US 10 cent piece (dime) could be helpful. It is important to insure that multiple measurements are taken to achieve the lowest haze value after the wipe with the microfiber cloth.

The fingerprint testing process was repeated by different operators to obtain statistically significant data. This is important in this case since everyone has different skin oil compositions and will collect varying amounts of oil when they take a sample from their forehead. Also, the force of applying the fingerprint could vary slightly between individuals.

To evaluate all the data from the samples, the key points are the haze created by the fingerprint and the haze after a removal pass with the microfiber cloth. The percentage removal is the removal haze divided by the initial haze multiplied by 100 to yield a percentage. The data is in Table 5.

TABLE 5
fingerprint data

| | | | MEAN | | MEAN FP | MEAN FP |
|---|---|---|---|---|---|---|
| | | | initial | MEAN FP | removal | haze % |
| | | eqwt | haze | haze | Haze | removal |
| Example | Tg | OH | (n = 3) | (n = 3) | (n = 3) | (n = 3) |
| 1 | 22 | 185 | 1.04 | 6.77 | 1.85 | 72.8 |
| 2 | −21 | 485 | 1.1 | 6.56 | 2.06 | 68.6 |
| 3 | −27 | 259 | 0.82 | 4.53 | 1.59 | 64.2 |
| 4 | −3 | 448 | 1.1 | 6.31 | 1.75 | 72.2 |
| 5 | 23 | 485 | 0.67 | 5.30 | 1.41 | 73.1 |
| 6 | −3 | 325 | 0.87 | 5.45 | 1.44 | 69.6 |
| 7 | −28 | 375 | | 8.70 | 4.15 | 50.4 |

It is important to recognize with this data that haze values near 1 are not so visible to the naked eye, while values at 2 or more are likely visible. All the initial haze values were acceptable with these samples. So, while these numbers were not grossly different, there are likely perceptions by an observer that would separate the results of these samples.

Based on these data in Table 5, examples 1 and 5 had the best fingerprint removal performance. However, these samples did not perform well with scratch/mar. Sample 2 performed the best in scratch/mar testing, and it yields a haze value over 2 after removal of the fingerprint.

Example 4 performed well for fingerprint removal performance, and also had good response to scratch/mar. Based on these findings, Tg values between 5 and −15° C. and eqwt OH values greater than 350 were considered to be the optimum design space. It is possible that additives could allow the use of resins outside the space, but those formulas may require higher level of additives and may compromise other areas of the coating performance for touchable surfaces, such as anti-microbial performance.

We claim:

1. A stretchable film comprising:
a coating layer comprising the reaction product of:
(i) an oligomeric polyester resin wherein the oligomeric polyester resin has a glass transition temperature (Tg) of −15 to 10° C., a hydroxyl equivalent weight of 350 to 500 mgKOH/g; and
(ii) an aliphatic isocyanate, isocyanurate, allophanate, or biuret,
wherein the coating has a fingerprint removal haze under 2, a percent haze removal over 70 percent, an initial scratch/mar over 40% gloss retention, and a recovered scratch/mar over 85% gloss retention as measured by both % gloss retention after 24 hours and % gloss retention at 60° C., as defined herein.

2. The stretchable film of claim 1, wherein the oligomeric polyester resin comprises from about 45 to about 65 mole % 1,6-hexanediol, and from about 2 to about 15 mole % of a branched alkyl diol having 4-8 carbon atoms, and from about 5 to about 25 mole % of a 2,2,4,4-tetraalkylcyclobutane-1,3-diol, and from about 15 to about 35 mole % 1,1,1-trimethylolpropane or 1,1,1-trimethylolethane based on the total moles of hydroxyl components; and from about 30 to about 70 mole % isophthalic acid, and from about 20 to about 50 mole % of one or more of hexahydrophthalic anhydride, methyl hexahydrophthalic, or tetrahydrophthalic anhydride, and from about 10 to about 30 mole % of one or more cyclic or acyclic aliphatic acids having from 2 to 12 carbons based on the total moles of acid components.

3. The stretchable film of any of claim 1, wherein the oligomeric polyester resin comprises from about 50 to about 60 mole % 1,6-hexanediol, and from about 5 to about 10 mole % 2,2-dimethyl-1,3-propanediol, and from about 10 to about 20 mole % 2,2,4,4-tetramethyl-1,3-cyclobutanediol, and from about 20 to about 30 mole % 1,1,1-trimethylolpropane based on the total moles of hydroxyl components; and from about 40 to about 60 mole % isophthalic acid, and from about 25 to about 40 mole % hexahydrophthalic anhydride, and from about 15 to about 25 mole % adipic acid based on the total moles of acid components.

4. The stretchable film of claim 1, wherein the oligomeric polyester resin comprises from about 40 to about 50 mole % isophthalic acid, or from about 5 to about 15 mole % terephthalic acid.

5. The stretchable film of claim 2, wherein the branched alkyl diol having 4-8 carbon atoms comprises one or more of 2,2-dimethyl-1,3-propanediol, 2-butyl-, 2-ethyl-1,3-propanediol, or 2-methyl-1,3-propanediol.

6. The stretchable film of claim 2, wherein the 2,2,4,4-tetraalkylcyclobutane-1,3-diol comprises one or more of: 2,2,4,4-tetramethylcyclobutane-1,3-diol (TMCD), 2,2,4,4-tetraethylcyclobutane-1,3-diol, 2,2,4,4-tetra-n-propylcyclobutane-1,3-diol, and 2,2,4,4-tetra-n-butylcyclobutane-1,3-diol.

7. The stretchable film of claim 1, wherein the oligomeric polyester resin has a number average molecular weight of 500 to 10,000 mgKOH/g, and a weight average molecular weight of 1000 to 40,000.

8. The stretchable film of claim 1, further comprising a thermoplastic elastomer substrate, adjacent the coating layer.

9. The stretchable film of claim 8, further comprising a pressure sensitive adhesive layer, on a side of the thermoplastic elastomer substrate opposite the coating layer.

10. The stretchable film of claim 1, further comprising a thermoplastic polyurethane substrate, adjacent the coating layer.

11. The stretchable film of claim 1, wherein the oligomeric polyester resin has a glass transition temperature (Tg) of −12 to 8° C., and a hydroxyl equivalent weight of 375 to 475 mgKOH/g.

12. The stretchable film of claim 1, wherein the oligomeric polyester resin has a glass transition temperature (Tg) of −10 to 5° C., a hydroxyl equivalent weight of 400 to 475 mgKOH/g.

13. The stretchable film of claim 1, wherein the oligomeric polyester resin has a glass transition temperature (Tg) of −5 to 0° C., and a hydroxyl equivalent weight of 425 to 465 mgKOH/g.

14. The stretchable film of claim 1, wherein the oligomeric polyester resin has a number average molecular weight of 750 to 7,500 mgKOH/g, and a weight average molecular weight of 1500 to 30,000.

15. The stretchable film of claim 1, wherein the oligomeric polyester resin has a number average molecular weight of 1000 to 5,000 mgKOH/g, and a weight average molecular weight of 1800 to 25,000.

16. The stretchable film of claim 1, wherein the thickness of the coating layer is from 0.1 to 25 microns thick, or from 1 to 15 microns thick.

17. The stretchable film of claim 1, wherein the aliphatic isocyanate is an aliphatic diisocyanate, and wherein the aliphatic diisocyanate is present and is selected from one or more of: methylenebis-4,4′-isocyanatocyclohexane, isophorone diisocyanate, isocyanurates of isophorone diisocyanate, 1,6-hexamethylene diisocyanate, isocyanurates of 1,6-hexamethylene diisocyanate, 1,4-cyclohexane diisocyanate, pentane-1,5-diisocyanate, 1,4-bis(isocyanatomethyl)cyclohexane, or a polyisocyanate.

18. The stretchable film of claim 17, wherein the aliphatic diisocyanate is present and corresponds to one of the following structures:

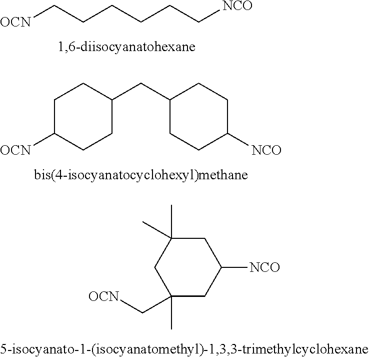

19. The stretchable film of claim 1, wherein the mole ratio of oligomeric polyester resin to aliphatic isocyanate or isocyanurate, is from 0.95 to 1.05.

20. The stretchable film of claim 1, wherein the stretchable film exhibits an elongation at break of at least 50%, or at least 60%.
